(19) United States
(12) Patent Application Publication
(10) Pub. No.: US 2006/0247128 A1
(43) Pub. Date: Nov. 2, 2006

(54) Chemical supplement for agricultural uses

(75) Inventor: Gerald Gigot, Garden City, KS (US)

Correspondence Address: Mark E. Ogram, 7454 E. Broadway # 203, Tucson, AZ, 85710, US

(73) Assignee: Gigot Aqua Solutions (A Kansas Corporation), Garden City, KS (US)

(21) Appl. No.: 11/119,382

(22) Filed: Apr. 28, 2005

(51) Int. Cl. A01N 59/04; A01N 63/00; A01N 25/10

(52) U.S. Cl. 504/101; 504/117; 504/360

(57) ABSTRACT

A combination for enhancing an agricultural site in which a blend of an absorbent polymer having a mesh size of 40 to 70 is combined with at least one liquid additive. When combined, sufficient amount of the liquid additive is applied to the blend so that the absorbent polymer no longer recognizes water; hence, the polymer is “saturated” with the additive. In one embodiment of the invention, two liquid additives are used; a first liquid additive including a liquid fertilizer and a second liquid additive which includes a liquid insecticide.

### BACKGROUND OF THE INVENTION

This invention relates generally to agriculture products and more particularly to supplements used to enhance yields.

A growing trend in the agriculture industry is the use of liquid fertilizer products rather than dry glanular fertilizer to increase the quality and quantity and lower the cost of producing a profitable crop.

Another growing trend is the use of the super absorbent polymers to retard the leaching of applied water and chemicals. Absorbent polymers have been proven through experiments in significant acreage installations throughout the nation to have beneficial affects on the crop yields and reduction in chemical leeching.

When these two components are combined, the combination of liquid fertilizers and super absorbent polymers generates crop benefits in the form of quality and quantity greater than the sum of the benefits generated form each individual component. The problem with this combination is that in using the polymer at the rate of 1-2 pounds/acre ( for the purpose of increasing the rate of seed germination and increasing root mass) which was placed in very small quantities directly in the seed plant row provides significant application problems.

It is well known that use of a super absorbent polymer when properly applied in significantly greater amounts provides a series of environmental benefits that are more significant than the increase rate of germination. One such application is U.S. Pat. No. 5,659,998 entitled “Water-Absorbent Polymer Mixture for Underground Dispersion” issued on Aug. 26, 1997, to Salestrom, incorporated hereinto by reference.

These benefits include dramatic reduction in the leaching of nitrates and other harmful chemicals into the underground water supplies, and will also dramatically reduce the harmful agriculture chemical runoff into the surface water bodies. Because of the seemingly world-wide crises in the available water supplies for irrigation, the super absorbent polymer greatly reduces the required amount of water to raise a crop; but, in order to generate these benefits, the rate of application of the super absorbent polymer has to be increased from the previous reference of 1-2 pounds/acre to 10-50 pounds and is ideally 18-40 pounds/acre.

This increase in the amount of absorbent polymer though presents a host of practical problems (such as clogging of nozzles; separation of materials; and precipitation of the polymer from the mix). Because of this, the full potential of the combination is not obtainable.

It is clear from the foregoing that there is a need to recognize the potential that the combination is able to achieve.

### SUMMARY OF THE INVENTION

Within the present discussion, the liquid additive being used with the polymer is a liquid fertilizer; but, the invention is not intended to be so limited and includes liquid herbicides and liquid insecticides as well. Further, the invention also contemplates the use of any combination of fertilizer, herbicide, and insecticides in combination with the super absorbent polymer.

The invention creates a combination for enhancing an agricultural sites and provides a blend of an absorbent polymer having a mesh size of 40 to 70 together with at least one liquid additive. The liquid additive is combined with the super absorbent polymer at a level that the polymer and the additive are “balanced”.

When combined, sufficient amount of the liquid additive is applied to the blend so that the absorbent polymer no longer recognizes water; hence, the polymer is “saturated” with the liquid additive which is released into the agriculture site over time.

In one embodiment of the invention, two liquid additives are used; a first liquid additive including a liquid fertilizer and a second liquid additive which includes a liquid insecticide. This approach permits the farmer to customize the application to meet the specific needs at the time.

In more detail, utilizing the basic N-P-K in liquid form of fertilizer, only the (K) has any significant amount of water. This is available to the polymer when mixed, therefore, the amount of potassium (K) is be kept to a minimum in the present invention.

Starter fertilizer is often utilized in huge quantities at a time of planting and injected into the ground in the general area of the seed placement, and is designated as a 10-34-0. In some applications the use of 3% potassium is also acceptable.

The invention recognizes that all NPK fertilizers have an anionic change. The super absorbent polymer has a cationic charge. Depending upon the amount of nitrogen and phosphorus, the farmer needs to apply per acre, the polymer is added to the base mixture of fertilizer until the charge between the two ingredients cancels out; the mixture ideally has a zero charge.

At this point the granular polymer becomes very slightly hydrated, very flexible, increases in size and weight by 10 to 20% and no longer recognizes water. This condition permits the addition of water without affecting the amount of fertilizer being applied to the agriculture field.

In practice, for the invention to be properly applied, the polymer must be suspended within the liquid fertilizer. When the fertilizer tank is mounted on a tractor, the extra force of gravity caused by the bouncing over the uneven field as the tractor travels, causes the suspended polymer to settle and eventually plugs the pumps and orifices. To eliminate this affect, the invention provides for circulation of the traveling system.

Further, once the blend of polymer and liquid fertilizer has been made, the blended mixture is ideally agitated when not being applied to the agricultural field.

Ideally, the super absorbent polymer is in the range of 40-70 mesh with an ideal size of 50 to 60 mesh. This provides for optimum grain size for the super absorbent polymer. This particular size is advantageous as it permits the easy pumping of the blend and creates the semi-permeable barrier in the soil to enhance the water retention qualities of the soil.

The ideal pumps for the present application are: squeeze pumps; and, centrifugal or piston pumps for accurate application metering. These pumps do little damage to the polymer. It has been found that vane and gear-type pumps, may cause damage to the polymer by shearing the hydrated polymer crystals; hence, additional care should be when these types of pumps are used.

When mixing the super absorbent polymer into the fertilizer, a 50-60 mesh size polymer granular is used to assist in the mixing of large volumes and maintaining the polymer in suspension. A preferred size for the polymer is 40-50 mesh.

For differing applications, the methods of application are as follows:
a. For application in the seed row, a rate of 1-2 pounds/acres (use caution that too high a rate of fertilizer is not used as this can cause germination damage).
b. For application as a side dress, the blend should be applied two inches below and two inches to the side of the seed row. It has been found that up to six pounds/acres can be applied by this method.
c. When the intent is to retard the leaching of nitrates and/or other chemicals, and to increase water efficiency, the blend is applied using a coulter with the coulters spaced at ten inches or less. Injector nozzles mounted behind the coulters apply the fertilizer/polymer mix. This allows lateral migration of the polymer in the soil to create the overall semi-permeable barrier necessary for optimum water efficiency and retard leaching without creating an oxygen barrier. It has been found that polymer application rates to create this semi-permeable barrier at ten inches injector spacing may vary from 20-40 pounds/acre without creating undesireable results. The injector nozzles should be operated at 50-80 PSI to produce the optimum polymer distribution. Ideally, to avoid damage and plugging of the nozzle, the nozzle size should be 0.057 or larger at a depth in the range of five to six inches.

Such methods of application using a coulter or other blending techniques are described in: U.S. Pat. No. 5,303,663, entitled “Subsurface, Particle Injection Methods” issued to Salestrom on Apr. 19, 1994; U.S. Pat. No. 5,649,495, entitled “Agricultural Water Retention Mixture and Application Technique” issued to Salestrom on Jul. 22, 1997; and U.S. Pat. No. 5,868,087, entitled “Agricultural Water Retention and Flow Enhancement Mixture” issued to Salestrom on Feb. 9, 1999; all of which are incorporated hereinto by reference.

This method has been shown to significantly increase the crop yield over the use of either the polymer or fertilizer alone. The he increased affect is based on the ability of the polymers to hold moisture, fertilizer, insecticides, and herbicides for a longer period of time in the root zone, for optimum utilization of moisture, nutrients, and chemicals for the plant. This method also increases root development of the crop to aid in its ability to resist drought; therefore increasing production.

In yet another embodiment of the invention, a soil enhancing microbe is added to the polymer to address specific conditions within the soil. This embodiment is particularly beneficial for turf. The standard formulation for turf in this embodiment of the invention with the standard NPK being 4-8-0-1-1.

Those of ordinary skill in the art readily recognize a variety of soil enhancing microbes which are useful in this context, including, but not limited to, the microbes described in: U.S. Pat. No. 6,871,446, entitled Microbial Blend Compositions and Methods for Their Use” issued to Yamashita on Mar. 29, 2005; U.S. Pat. No. 6,874,277, entitled “Method and Composition for Promoting and Controlling Growth of Plants”, issued to Yamashit on Apr. 5, 2005; and U.S. Pat. No. 6,878,179, entitled “Fertilizer Compositions and Methods of Making and Using Same” issued to Porubcan on Apr. 12, 2005; all of which are incorporated hereinto by reference.

The invention, together with various embodiments thereof, will be more fully explained by the accompanying drawings and the following descriptions thereof.

### DRAWINGS IN BRIEF

FIG. 1 graphically illustrates the creation of the blend of the present invention.

FIG. 2 graphically illustrates the application of the blend into the soil of the agricultural site.

### DRAWINGS IN DETAIL

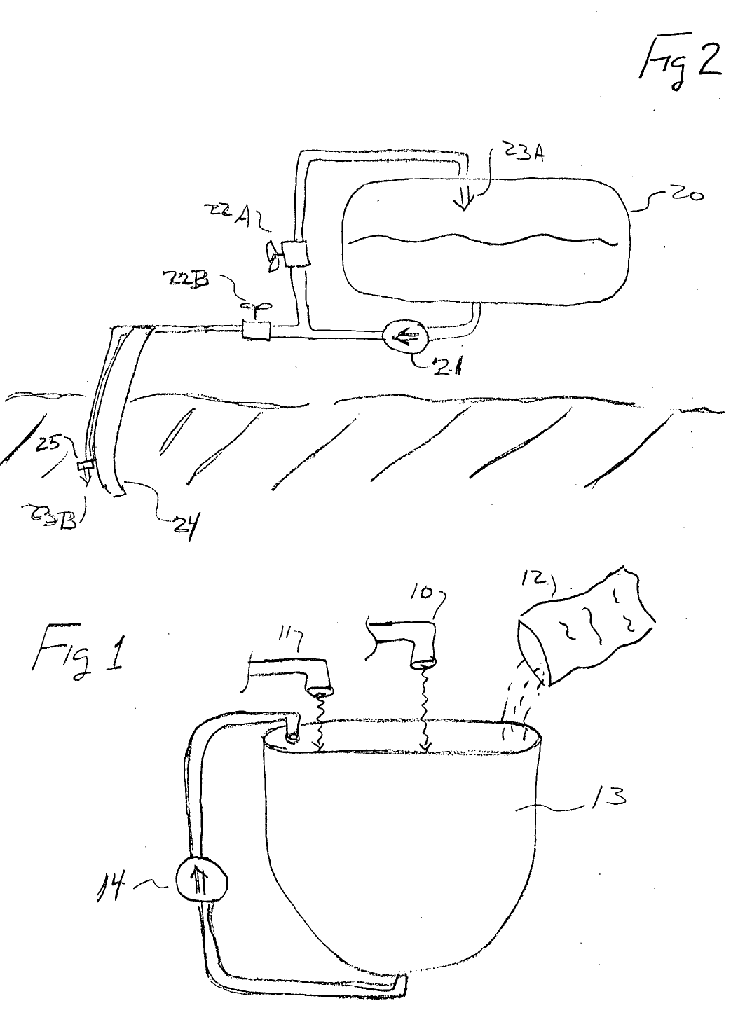

FIG. 1 graphically illustrates the creation of the blend of the present invention.

In this embodiment, the liquid fertilizer 10 is placed within the mixing container 13. In the case of starter fertilizer, the ideal composition for the fertilizer is a 10-34-0 relationship. In some applications the use of 3% potassium is also contemplated.

This embodiment of the invention also contemplates the inclusion of another additive such as a liquid insecticide 11.

As noted earlier, all NPK fertilizers have an anionic change while the super absorbent polymer has a cationic charge. Polymer 12 is added to the base mixture of fertilizer 10 within the mixing container 13 until the charge between the two ingredients substantially cancels out; the mixture has a substantially zero charge. At this point the granular polymer becomes very slightly hydrated, very flexible, increases in size and weight by 10 to 20% and no longer recognizes water. This condition permits the addition of water without affecting the amount of fertilizer being applied to the agriculture field.

In this preferred embodiment, the super absorbent polymer 12 is in the range of 50 to 60 mesh because the resulting blend permits easy pumping of the blend and creates the semi-permeable barrier in the soil to enhance the water retention qualities of the soil.

The blend is maintained through the use of pump 14 which circulates the blend within the mixing container 13. Pump 14 is a squeeze pump or a centrifugal pump.

FIG. 2 graphically illustrates the application of the blend into the soil of the agricultural site.

During the application of the blend to the agricultural site, the polymer must be suspended within the liquid fertilizer. To accomplish this, pump 21 pulls the blend from vat 20. Pump 21 must be operated to counteract the extra force of gravity caused by the erratic travel over the rough agricultural field.

When the tractor is not in use, valve 22A is opened and valve 22B is closed; the blend then circulates back into vat 20 as illustrated by arrow 23A to maintain suspension of the polymer within the blend.

When the tractor is in use and the blend is to be dispersed into the agricultural site, valve 22A is closed and valve 22B is open. This directs the blend from vat 20 to be dispersed as shown by arrow 23B which is positioned behind coulter 24 (which is pulled through the soil).

This configuration permits the blend to be applied to meet the needs of the farmer's particular situation.

Injector nozzles 25 mounted behind coulter 24 apply the fertilizer/polymer mix. This allows lateral migration of the polymer in the soil to create the overall semi-permeable barrier necessary for optimum water efficiency and retard leaching without crating an oxygen barrier. Ideally the polymer application rate in this scenario is ten inches injector spacing with the application of the blend being in the range of 20-40 pounds/acre. The injector nozzles should be operated at 50-80 PSI to produce the optimum polymer distribution and the nozzle size should be 0.057 or larger at a depth of depth in the range of five to six inches.

It is clear that the present invention provides for a highly improved additive for use in agricultural settings.

What is claimed is:

1. A combination for agriculture comprising:
a) an absorbent polymer having a mesh size of 40 to 70; and,
b) a growth enhancing additive for agriculture, said liquid additive being combined with said absorbent polymer prior to application of such combination onto an agricultural site.

2. The combination according to claim 1, wherein said growth enhancing liquid additive is a liquid fertilizer.

3. The combination according claim 2, wherein said liquid fertilizer has less than five per-cent potassium.

4. The combination according to claim 1, wherein said growth enhancing liquid additive is a liquid insecticide.

5. The combination according to claim 1, wherein said growth enhancing liquid additive is a liquid herbicide.

6. The combination according to claim 1, wherein said growth enhancing liquid additive is a soil enhancing microbe.

7. The combination according to claim 1, wherein a combined anionic and cationic charge of the additive and absorbent polymer is substantially zero.

8. The combination according to claim 7, wherein the amount of liquid additive is sufficient such that the absorbent polymer no longer recognizes water.

9. The combination according to claim 6, wherein said absorbent polymer and said liquid additive are continuously circulated prior to application into an agricultural site.

10. The combination according to claim 9, wherein said absorbent polymer is applied to the agricultural site at the rate of 10-50 pounds per acre in a dry state.

11. The combination according to claim 10, wherein said combination is applied four to eight inches below the surface of the agricultural site.

12. A growth enhancing blend for agricultural applications comprising:
a) an absorbent polymer having a mesh size of 40 to 70; and,
b) an growth enhancing liquid additive for agriculture, said liquid additive being absorbed by said absorbent polymer.

13. The growth enhancing blend according to claim 12, wherein said liquid additive and said absorbent polymer are blended at an agricultural site.

14. The growth enhancing blend additive according to claim 13, wherein said liquid additive is a liquid fertilizer having less than five per-cent potassium.

15. The growth enhancing blend according to claim 12, wherein a combined anionic and cationic charge of the liquid additive and the absorbent polymer is substantially zero.

16. A combination for enhancing an agricultural site comprising:
a) an absorbent polymer having a mesh size of 40 to 70; and,
b) a first liquid additive for agriculture; and,
c) a second liquid additive for agriculture,
wherein when said first additive and said second additive are added in sufficient quantity to said absorbent polymer, such that said absorbent polymer no longer recognizes water.

17. The combination for enhancing an agricultural site according to claim 16,
a) wherein said first liquid additive includes a liquid fertilizer; and,
b) wherein said liquid second additive includes a liquid insecticide.

18. The combination for enhancing an agricultural site according to claim 17, wherein said combination is continuously circulated prior to application into the agricultural site.

19. The combination for enhancing an agricultural site according to claim 18, wherein, in a dry state, said absorbent polymer is applied to the agricultural site at the rate of 10-50 pounds per acre.

20. The combination for enhancing an agricultural site according to claim 19, wherein said combination is applied four to eight inches below a surface of the agricultural site.
